(19) United States
(12) Patent Application Publication
(10) Pub. No.: US 2010/0012047 A1
(43) Pub. Date: Jan. 21, 2010

(54) Veterinary Surgical Drape

(75) Inventors: David Larkins, Manchester, MD (US); James Bell, Manchester, MD (US)

Correspondence Address: K&L Gates LLP, P.O. BOX 1135, CHICAGO, IL, 60690, US

(73) Assignee: Spacedrapes, Inc., Manchester, MD (US)

(21) Appl. No.: 12/174,814

(22) Filed: Jul. 17, 2008

(51) Int. Cl. A01K 13/00

(52) U.S. Cl. 119/850

(57) ABSTRACT

The present invention relates to a method of reducing heat loss from a non-human animal. The method can include the steps of providing a cover having a first side with a reflective material sized and configured for covering at least a portion of a non-human animals body, and a layer of material, and covering at least a portion of the non-human animal during a surgical procedure with the cover.

### BACKGROUND

Heat loss in animals during surgical procedures often leads to hypothermia. Such heat loss may be caused by several factors, including anesthesia, general anesthetics, muscle relaxants, cold, dry anesthetic gases and cool surgical or other procedural rooms. Hypothermia can result in poor surgical results including death or prolonged recovery periods.

The major causes of heat loss in the surgical or other procedural rooms are radiation, convection and evaporation. Radiant heat loss is a function of the difference between the patient's body temperature and the temperature of the surgical or other procedural rooms. Convective heat loss is a function of ambient temperature and the square root of air velocity. Evaporative heat loss consists of two components, respired vapor loss and evaporative skin loss. Evaporative skin loss is a function of temperature and humidity gradients at the animal body surface.

Animals on the procedure table may lose considerable amounts of heat by radiation, convection and evaporation into the environment of the procedure or other surgical room. The resultant low body temperature is one of the most common causes of the stoppage of breathing following general anesthesia. Frequently the animal must be rewarmed before spontaneous respiration resumes. It is therefore essential that an animal in the operating room be kept normothermic.

Such heat loss is even more significant in non-human animals. Animals have a much higher ratio of surface area to body mass than humans, increasing the need to retain body heat during anesthesia. Consequences of long recovery time or mortality due to anesthesia and heat loss are greater for humans than animals; humans tend to merit more costly heat retention equipment and methods.

It is therefore apparent that reducing the heat loss from a non-human animal will improve the animal's chance of survival and speedy recovery from the surgical procedure.

### SUMMARY

The present invention relates to a method of reducing heat loss from a non-human animal. The method can include the steps of providing a cover having a first side with a reflective material sized and configured for covering at least a portion of a non-human animals body, and a layer of material, and covering at least a portion of the non-human animal during a surgical procedure with the cover.

The present invention also relates to a cover. The cover can include a first side with a reflective material sized and configured for covering at least a portion of a non-human animal's body and a layer of material.

The present invention also relates to a method of reducing heat loss from a non-human animal. The method can include the steps of providing a cover having a first side with a reflective material sized and configured for covering a predetermined portion of a non-human animal's body, and a layer of material, and covering at least a portion of the non-human animal during the substantially the entire time the non-human animal is anesthetized.

Additional features and advantages are described herein, and will be apparent from, the following Detailed Description and the figures.

### BRIEF DESCRIPTION OF THE FIGURES

FIG. 1 is a cross section of one embodiment of the drape.

FIG. 2 is a view of the surgical drape covering an animal.

### DETAILED DESCRIPTION

The present invention relates to a surgical drape or cover which is able to reduce heat loss in non-human animal patients by reflecting body heat back to the animal and may also reduce heat loss by providing a moisture barrier that reduces evaporative cooling of the animal. The cover can be used specifically to “reduce mortality,” “decrease recovery time” and “improve recovery prospects” in anesthetized non-human animals. The cover may also be used to provide an aseptic barrier for animal patients during a variety of surgical procedures. Furthermore, the drape can be sterilized, if desired.

The surgical drape or cover can reduce a non-human animal patient's rate of heat loss before during and after a surgical procedure. Preferably the drape is sized and configured to cover a small rodent, such as a mouse, but can be sized and configured to cover any type or size non-human animal. The drape can be used at any time during which the non-human animal is anesthetized. Non-human animals generally have a tendency to rip or destroy any covering or drape when not anesthetized; but it is noted that, if desired the cover can be used at any time for a non-human animal. The drape can be sized and configured to cover the entire non-human animal, a portion of the non-human animal or a predetermined or specific portion of the non-human animal. For example, the cover may be used for a variety of surgical procedures and may take several forms, including full and partial body length drapes, as well as covering limbs and/or the head.

The cover can include a metallized plastic sheeting and at least one of (a) a layer of thermoplastic material; and (b) a layer of material. The layer of material can be a flexible non-woven material or any other suitable material.

For example, the cover can have a non-conductive core layer of aluminum and a first and second adjacent layer of a thermoplastic material. A layer of flexible non-woven material can attached to either the first or second adjacent layer of thermoplastic material. The cover can include any combination of these materials, including lacking each material/layer, such that only one material/layer exists, or the materials layers can be duplicated, triplicated, etc., or any combination of these materials/layers can be produced with each material/layer occurring between zero and as many times as desired. Furthermore, the materials layers can occur in any order and be positioned adjacent any other material/layer.

The cover can include a non-conductive metalized plastic sheeting. If desired the metalized layer can deposited directly on a drape material, such as the flexible non-woven material.

Referring now to the drawings, and in particular FIG. 2, a reflective surgical drape or cover 3 is used for covering an animal surgical patient and reducing heat loss from the non-human animal body before, during and after a surgical procedure, In addition to preventing heat loss, when the cover 3 can be provided in a sterile condition, such that it could be used as a sterile drape.

As shown in FIG. 2, the cover 3 may be fashioned as a blanket which can be wrapped closely about a portion or the entire body of the non-human animal patient undergoing a surgical procedure. Those skilled in the art will recognize that the reflective surgical drape or cover may be sized and configured to cover any desired portion of the body of a non-human animal patient undergoing a surgical procedure. Generally, the non-human animal can be significantly smaller then a human, such as a mouse, rat or other small rodent; however, it is noted that cover 3 can be suitable for any sized non-human animal and is not limited to use with a small rodent.

As noted above, when provided in a sterile condition, the cover can be used as a sterile drape. Any suitable or desired fenestrations or openings can be provided in the cover to provide access through the cover to a desired portion of the body of the non-human animal patient undergoing a surgical procedure.

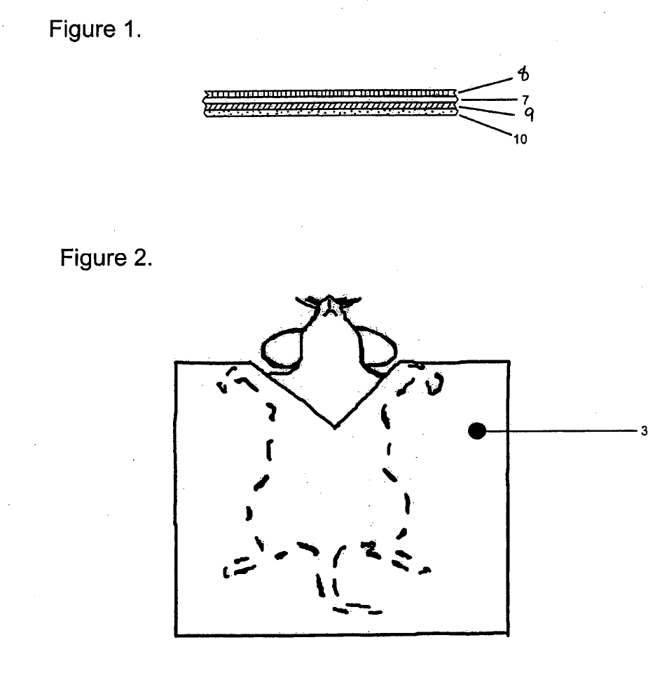

As shown in FIG. 1, one embodiment of the drape of the present invention is a four-layer drape having a core layer 7, first and second adjacent layers 8,9 and an outer layer 10 attached to the second adjacent layer 9. Those skilled in the art will recognize that outer layer 10 may be attached to either the first or second adjacent layers 8, 9. The core layer 7 can be aluminum and is non-conductive. The first and second adjacent layers 8, 9 can be a thermoplastic material. The outer layer 10 can be a flexible non-woven material. However, it is noted that the cover 3 does not need to be configured in this manner and can be configured in any suitable manner with any number of suitable layers and/or with each layer being any suitable material.

The non-conductive core layer 7 of aluminum, preferably, is vacuum deposited or sputtered in a non-continuous manner on the first adjacent layer 8 of thermoplastic material. The aluminum can be replaced by other heat reflective metals such as gold and silver or any other suitable substance. In a preferred embodiment, the layer of aluminum has a thickness of from about 270 .ANG. to about 330 .ANG., and in a most preferred embodiment, it has a thickness of approximately 300 .ANG.; but can be any desired or suitable thickness. The non-conductive core layer 7 of aluminum is preferably substantially enclosed or sandwiched between the first and second adjacent layers 8, 9 of thermoplastic material. The second adjacent layer 9 of thermoplastic material is preferably laminated to the non-conductive core layer 7 of aluminum using an adhesive. The adhesive is preferably moisture-proof and is most preferably an acrylic moisture-proof adhesive. Alternatively, the second adjacent layer 9 of thermoplastic material can be heat extruded to the non-conductive core layer 7 of aluminum. Other suitable methods may be utilized for permanently adhering the second adjacent layer 8 of thermoplastic material to the non-conductive core layer 7 of aluminum, if desired. It is noted that the layers do not necessarily need to be permanently adhered and can be temporarily or semi-permanently adhered more merely adjacent thereto, if they exist.

The thermoplastic material of the first and second adjacent layers 8, 9 can be flexible but need not be transparent. The thermoplastic material of the first and second adjacent layers 8, 9 can be low-density polyethylene, medium-density polyethylene, polypropylene, polyester or polybutylene. The thermoplastic material of the first and second adjacent layers 8, 9 can be a low-density polyethylene; however, other flexible (or suitable) thermoplastic materials including biodegradable materials may be used as the thermoplastic material of the first and second adjacent layer 8, 9. The first and second adjacent layers 8, 9 preferably have a thickness of from 0.00120 to 0.00130 mils and most preferably have a thickness of 0.00125 mils; but can be any desired or suitable thickness. The thermoplastic material of the first and second adjacent layers 8, 9 can aid in the retention and reflection of body heat and can provide puncture resistance to the cover.

As noted above, the outer layer 10 of flexible non-woven material can be attached to either the first or second adjacent layer 8, 9. The layer 10 of flexible non-woven material is preferably attached to the first or second adjacent layer 8, 9 using an adhesive. The adhesive is preferably moisture-proof and is most preferably an acrylic moisture-proof adhesive.

As discussed above, if desired, layers or materials can be omitted or replicated. For example, the second adjacent layer 9 can be omitted and the layer 10 of flexible non-woven material can attached to the non-conductive core layer 7 of aluminum. The layer 10 of flexible non-woven material is preferably attached to the non-conductive core layer 7 of aluminum using an adhesive, or any other suitable means. The adhesive is preferably moisture-proof and is most preferably an acrylic moisture-proof adhesive.

In another embodiment, the first adjacent layer 8 can be omitted and the layer 10 of flexible non-woven material can be attached to the second adjacent layer 9. The non-conductive core layer 7 of aluminum can be vacuum deposited on the second adjacent layer 9.

In a another embodiment, the layer 10 of flexible non-woven material can be omitted, In this embodiment, the cover can include the non-conductive core layer 7 of aluminum and the first and second adjacent layers 8, 9.

In another embodiment, the layer 10 of flexible non-woven material and the second adjacent layer 9 can be omitted. In this embodiment, the cover can include the non-conductive core layer 7 of aluminum and the first adjacent layer 8.

It is noted that each of the embodiment are examples and the cover can include any number of suitable layers and/or materials.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of reducing heat loss from a non-human animal, comprising the steps of
providing a cover having a first side with a reflective material sized and configured for covering at least a portion of a non-human animals body, and a layer of material, and
covering at least a portion of the non-human animal during a surgical procedure with the cover.

2. A method according to claim 1, wherein
the covering step includes covering a rodent during at least one of the following: the recovery stage and when rodent is anesthetized.

3. A method according to claim 2, further including the step of
sterilizing the cover.

4. A method according to claim 1, wherein
the providing step includes providing a cover that is sized and configured for a predetermined portion of the non-human animal's body.

5. A method according to claim 1, wherein
the reflective material is metalized and is deposited directly on the material.

6. A method according to claim 1, wherein the providing step includes providing a cover including a non-conductive core layer of aluminum vacuum deposited to a thermoplastic material layer.

7. A cover according to claim 6, wherein said thermoplastic material of is selected from the group consisting of low-density polyethylene, medium-density polyethylene, polypropylene, polyester and polybutylene.

8. A cover according to claim 1, wherein said layer of material is one or a blend of cotton, polyester, rayon, polypropylene or cellulose.

9. A cover according to claim 8, wherein said layer of material is attached with an adhesive to a thermoplastic material layer.

10. A cover, comprising:
a first side with a reflective material sized and configured for covering at least a portion of a non-human animals body; and
a layer of material.

11. A cover according to claim 10, further comprising a non-conductive core layer of aluminum vacuum deposited to a thermoplastic material layer.

12. A cover according to claim 11, wherein said thermoplastic material of is selected from the group consisting of low-density polyethylene, medium-density polyethylene, polypropylene, polyester and polybutylene.

13. A cover according to claim 10, wherein said layer of material is one or a blend of cotton, polyester, rayon, polypropylene or cellulose.

14. A cover according to claim 10, wherein said layer of material is attached with an adhesive to a thermoplastic material layer.

15. A cover according to claim 10, wherein
said cover is configured to reduce heat loss from a rodent.

16. A cover according to claim 10 wherein
the reflective material is metalized and is deposited directly on the material.

17. A method of reducing heat loss from a rodent, comprising the steps of
providing a cover having a first side with a reflective material sized and configured for covering a predetermined portion of a rodent's body, and a layer of material, and
covering at least a portion of the rodent during the substantially the entire time the rodent is anesthetized.

18. A method according to claim 17, wherein
the reflective material is metalized and is deposited directly on the material.

19. A method according to claim 17, wherein the providing step includes providing a cover including a non-conductive core layer of aluminum vacuum deposited to a thermoplastic material layer.

20. A cover according to claim 17, wherein said thermoplastic material of is selected from the group consisting of low-density polyethylene, medium-density polyethylene, polypropylene, polyester and polybutylene.
